(19) United States
(12) Patent Application Publication
(10) Pub. No.: US 2005/0266130 A1
(43) Pub. Date: Dec. 1, 2005

(54) Method for solidification and storing of components extracted from plant, animal, or mineral matter and extract components extracted from held plant, animal, or mineral matter

(76) Inventor: Henry Aoki, Acton, MA (US)

Correspondence Address: Lipsitz & McAllister, LLC, 755 MAIN STREET, MONROE, CT, 06468, US

(21) Appl. No.: 10/857,297

(22) Filed: May 28, 2004

(51) Int. Cl. A23L 1/00

(52) U.S. Cl. 426/438

(57) ABSTRACT

Extraction of components from plant matter, animal matter, mineral matter, and other similar matter; rendering of the components in solid format; and long-term storage thereof. The above-mentioned problems are solved through the provision of methods for solidification and storage components extracted from raw materials comprising the steps of; (a) generating atomized fine particles of water heated using a heater heating stored water to a predetermined temperature and an atomized fine particle generating tank providing a means for atomization of the water; (b) depressurizing a raw material layer comprising crushed pieces of plant matter, animal matter, mineral matter, or other matter charged in an extraction device, and sucking and exuding out the surface the atomized fine particles the active components in said raw material; (c) absorbing the active components deposited on the raw material surface through suction and exudation into the atomized fine particles by circulating the atomized fine particles together with a flow of air in a cyclic fashion through the various component devices and passing through the depressurized raw material layer; (d) delivering the atomized fine particles holding the active components to a cooled condenser and condensing the particles; (e) instilling into a reservoir tank the water containing the active components of the various raw materials after being condensed by the condenser, and for obtaining the finished product; (f) re-circulating to the atomized fine particle generating tank the atomized fine particles not condensed in the condenser; (g) making the water containing the extracted components obtained through the preceding processes absorb in a flexible absorber or a porous absorber and drying the absorber; and (h) compressing the absorber when the absorber is the flexible absorber.

### BACKGROUND OF THE INVENTION

1. Field of the Invention

The present invention relates to methods for the solidification and storage of active components extracted from plant matter, animal matter, and mineral matter; to elements extracted from plant, animal, or mineral matter held in an absorber; and more specifically, to the composition of cosmetics, perfumes, flavor enhancers, or medicines and nutritional supplements effective against various diseases.

2. Description of the Related Art

U.S. Pat. No. 5,572,923, No. 5,170,697, and No. 477,610 disclose apparatuses related to extraction systems for the extraction of active components from malt, soya bean, and other raw materials.

These apparatuses comprise an atomized fine particle generating tank with a means for heating a water tank to a predetermined temperature; a means for atomizing the water; an extraction device connected to the atomized fine particle generating tank in order to make the atomized fine particles absorb the active components when the raw material is mounted and the atomized fine particles are passed through it; a condenser connected to the extraction device and condensing the atomized fine particles holding the active components; a reserve tank that stores the liquid from the condenser; a blower disposed between the reserve tank and the atomized fine particle generating tank to depressurize the raw material within the extraction device; and cooling means for the condenser and the reserve tank.

In the technique explained above, the extracted product is in liquid form and solidification thereof has previously been impossible. Nutritional supplements and medicines can be manufactured more easily from solid components than from liquid components, and solid products of extraction are therefore in demand. In terms of storage and transportation, solid components benefits from reduced cost when compared with liquid components. Furthermore, if solidification were possible, the storage stability of the products of extraction would also be enhanced.

The inventor of the present invention has found a processing technology enabling easier solidification of the liquid extraction products from the apparatuses explained above, and/or extraction products from an apparatus with an improved condenser and/or an improved drying means through drying or freezing and drying.

Using this technique, pharmaceutical compositions and nutritional compositions can be easily prepared from solidified extraction product or dried extraction product in the same way as components beneficial to the preparation of cosmetics, perfumes, and/or flavor enhancers.

In addition, the analysis of dried extraction product contained in an absorber is relatively easy when compared with analysis of the extraction product itself.

Natural product such as plant, animal, and mineral matter contain a wide range of useful components, both known and unknown. A number of different means are available for extracting this type of active component, such as extraction from brewed liquid, distillation method, and solution extraction method.

However, these extraction methods known in the prior art are characterized by an inability to effectively collect components from the target matter. For example, crude drugs often contain compounds that are destroyed by high temperatures or tiny amounts of active components that cannot be investigated using modern analytic technologies.

Accordingly, for example, when extracting components by brewing a Korean ginseng, or when extracting components by the distillation method, it is impossible to obtain components that cannot withstand high temperatures.

In addition, since accurate analysis of components is required in the solution extraction method, tiny volumes of unknown compounds present in Korean ginseng and other substances cannot be extracted by this method, and a number of other problems also exist.

Recent developments in the field of botany have also shown that, in addition to currently known components, each variety of plant contains several hundred unknown components, and the indispensable role that these components play with regard to physiological function have gradually revealed. As these compounds are present only in tiny volumes within plants, it is currently difficult to analyze and isolate them; however, research and development is being carried out into these so-called “phyto chemicals” with the expectation that they will also have a beneficial effect on human physiological function. Extraction technology is also an obstacle in this type of research and development project, and current techniques are often not suitable for the extraction of components from the plant being investigated.

As a result of this situation, therefore, regardless of whether a specific variety of plant is known or thought to be beneficial, it is often not possible to avail of its benefits.

The present invention addresses this problem.

### SUMMARY OF THE INVENTION

It is the object of present invention to provide technology for extracting from various beneficial substances active components including those minute-volume components not extractable using technologies known in the prior art, and also to provide technology for the solidification and storage of the extracted active components.

Specifically, the method for solidification and storage of the extracted components comprising the steps of;
(a) generating atomized fine particles of water heated using a heater heating stored water to a predetermined temperature and an atomized fine particle generating tank providing a means for atomization of the water;
(b) depressurizing a raw material layer comprising crushed pieces of plant matter, animal matter, mineral matter, or other matter charged in an extraction device, and sucking and exuding out the surface of the atomized fine particles the active components in the raw material;
(c) absorbing the active components deposited on the raw material surface through suction and exudation into the atomized fine particles by circulating the atomized fine particles together with a flow of air in a cyclic fashion through the various component devices and passing through the depressurized raw material layer;
(d) delivering the atomized fine particles holding the active components to a cooled condenser and condensing the particles;
(e) instilling into a reservoir tank the water containing the active components of the various raw materials after being condensed by the condenser, and for obtaining the finished product;
(f) re-circulating to the atomized fine particle generating tank the atomized fine particles not condensed in the condenser;
(g) making the water containing the extracted components obtained through the preceding processes absorb in a flexible absorber drying of the obtained absorber; and
(h) compressing the absorber holding the extracted components solidified through drying.

In the solidification and storage methods explained above, non-woven material comprising a multiplicity of natural fibers and/or synthesized fibers can be used as the flexible absorber.

In addition, a porous absorber can be used in place of the flexible absorber from the solidification and storage methods explained above.

Calcined carbides such as charcoal and activated charcoal or metal or resin plates containing innumerable pores or indentations on the surface may be used as the porous absorber.

In addition, the present invention provides components extracted from plant, animal, or mineral matter and solidified and stored in flexible absorbers by the following processes;
(a) a process for generating atomized fine particles of water heated using a heater heating stored water to a predetermined temperature and an atomized fine particle generating tank providing a means for atomization of the water;
(b) a process for depressurization of a raw material layer comprising crushed pieces of plant matter, animal matter, mineral matter, or other matter charged in an extraction device, and for suction and exudation of the active components in the raw material to the surface thereof;
(c) a process for absorbing the active components deposited on the raw material surface through suction and exudation into the atomized fine particles by circulating the atomized fine particles together with a flow of air in a cyclic fashion through the various component devices and passing through the depressurized raw material layer;
(d) a process for delivering the atomized fine particles holding the active components to a cooled condenser after being condensing the particles;
(e) a process for instillation into a reservoir tank of the water containing the active components of the various raw materials and condensed by the condenser, and for obtaining the finished product;
(f) a process for re-circulating to the atomized fine particle generating tank the atomized fine particles not condensed in the condenser;
(g) a process for absorption of the water containing the extracted components obtained through the preceding processes onto a flexible absorber and for drying of the obtained absorber; and
(h) a process for compression of the absorber holding the extracted components solidified through drying.

Non-woven material comprising a multiplicity of natural fibers and/or synthesized fibers can be used as the flexible absorber.

In addition, a porous absorber can be used in place of the flexible absorber, and calcined carbides such as charcoal and activated charcoal or metal or resin plates containing innumerable surface pores or indentations can be used as the porous absorber.

### BRIEF DESCRIPTION OF THE DRAWINGS

FIG. 1 is a block diagram showing the construction of a manufacturing apparatus and manufacturing method.

FIG. 2 is an external perspective view of the manufacturing apparatus.

FIG. 3 is an external perspective view of the interior of the cold storage chamber of the manufacturing apparatus.

FIG. 4 is an external perspective view of the external cylinders of the manufacturing apparatus.

FIG. 5 is an external perspective view showing the construction of the internal cylinders of the manufacturing apparatus.

### DESCRIPTION OF THE PREFERRED EMBODIMENTS

Raw materials applicable to the extraction system for manufacture of the extraction products according to the present invention are mung beans, soya beans, coffee beans (roasted and non-roasted), lentils, green peas, pinto beans, black soy beans, small red beans, kidney beans, white kidney beans, garbanzo beans, cannellini beans, Korean ginseng, tree bark, dried shiitake mushrooms, malt, jalapeno (hot Mexican peppers), mustard seeds, sesame seeds, celery seeds, poppy seeds, wild onion seeds, paprika, cardamom, sugar, and black pepper; furthermore, as applicable liquid-form raw materials, juices from aloe, fruits, berries, caviar, leaves, and seeds can be used.

Green beans, soya beans, coffee beans (non-roasted), and tree bark are preferable as raw materials, and above all, coffee beans are most applicable.

Hereinafter, the preferred methods for obtaining the extraction products according to the present invention will be described with reference to the accompanying drawings.

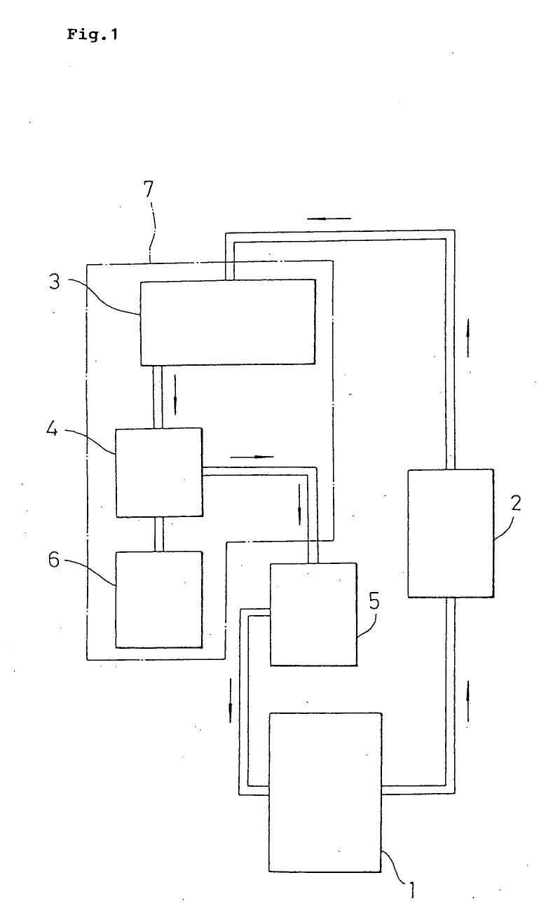

FIG. 1 is a block diagram showing the construction of the first embodiment of a manufacturing apparatus in which 1 is an atomized fine particle generating tank; 2 is an extraction device extracting active components from crude drugs and other raw materials using atomized fine particles delivered from the atomized fine particle generating tank 1; 3 is a condenser condensing the atomized fine particles transferred from the extraction device 2 and holding the active components from the raw materials; 4 is a reservoir tank for instillation of the water containing the active components of the raw materials liquefied at the condenser 3; and 5 is a blower disposed between the reservoir tank 4 and the atomized fine particle generating tank 1.

In addition, 6 is a secondary reservoir tank connecting with the reservoir tank 4, and 7 is a cooling means for cooling of the condenser 3, reservoir tank 4, and secondary reservoir tank 6. As shown in the figure, the atomized fine particle generating tank 1, the extraction device 2, and the other devices are inter-connected by connecting pipes thus forming a circulatory route centered around the atomized fine particle generating tank 1, and atomized fine particles pass in a cyclic fashion together with the flow of air around this circulatory route as a result of the action of the blower 5.

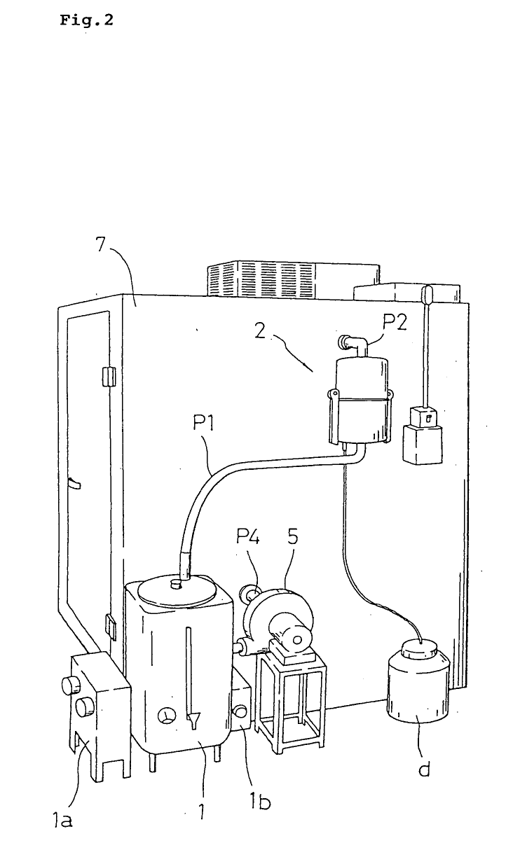

FIG. 2 is an external perspective view of a manufacturing apparatus having the construction explained above. In this figure, 1 is an atomized fine particle generating tank comprising a stainless-steel water tank of 35 cm in width, 35 cm in length, and 60 cm in height, in which between 30 and 40 liters of water is stored during operation. 1a is ultrasonic generator having eight pairs of oscillators disposed at the bottom of the water tank 1, each of which is capable of atomizing approximately 0.5 liters of water per hour. 1b is a heater for setting the water in the water tank 1 to a predetermined temperature.

Furthermore, 2 is an extraction device described hereinafter disposed on the side wall of a cold storage chamber 7 constituting the cooling means and connected to the atomized fine particle generating tank 1 by a flexible plastic pipe P1 of 38 mm in diameter and approximately 1.3 m in length. Note that d is a discharged water tank for receiving moisture discharged from the extraction device 2. P2 is a communication pipe connecting the extraction device 2 to the condenser 3 described hereinafter and constituted by a metal pipe of 40 mm in diameter.

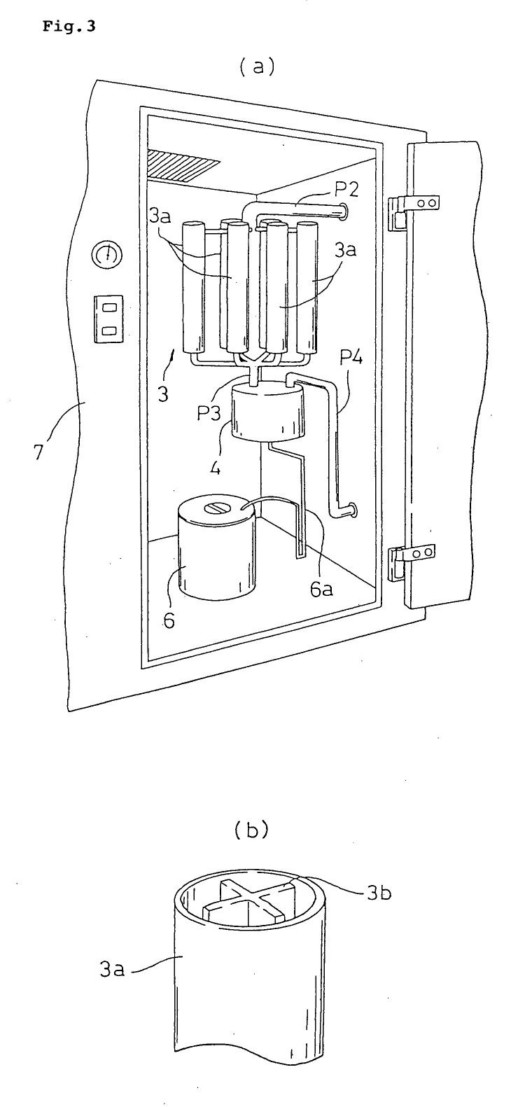

FIG. 3 (a) is an external perspective view of the interior of the cold storage chamber 7 in which 3 is a condenser constituted by a multiplicity (six in this embodiment) of condensing tubes 3a, and as explained above, connected to the extraction device 2 disposed outside the cold storage chamber 7 by the communication pipe P2. In this embodiment, each condensing tube 3a is a metal pipe of 85 mm in diameter and approximately 550 mm in length, and as shown in FIG. 3 (b), a cooling plate 3b is provided inside each condensing tube 3a. The top of each condensing tube 3a is connected to the communication pipe P2 by a branch pipe, and similarly, the bottom thereof is connected to a communication pipe P3 by a branch pipe.

4 is a reservoir tank connected to the condenser 3 by a communication pipe P3 of 40 mm in diameter and provided for the instillation of water liquefied from the atomized fine particles at the condenser 3. The top of the reservoir tank 4 and the blower 5 disposed outside the cold storage chamber 7 are connected by a communication pipe P4 of 40 mm in diameter. 6 is a secondary reservoir tank connected to the reservoir tank 4 by a drain pipe 6a. The cooling device is provided on the ceiling of the cold storage chamber 7; however, a window-type air conditioner may be installed on the side wall thereof in order to increase cooling performance.

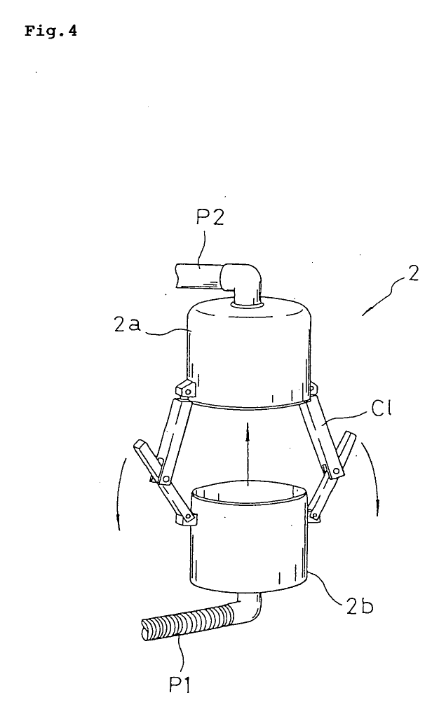

FIG. 4 is an external perspective view of the external cylinders constituting components of the extraction device 2 and comprising a primary external cylinder 2a and a secondary external cylinder 2b, both of which are supported with capability for free joining and separation through the action of a clamp C1, and each of which is a stainless steel member with a cylindrical shape of approximately 200 mm in diameter and approximately 150 mm in depth. Note that a temperature sensor for sensing of the temperature during extraction operation is attached to the lower secondary external cylinder 2b.

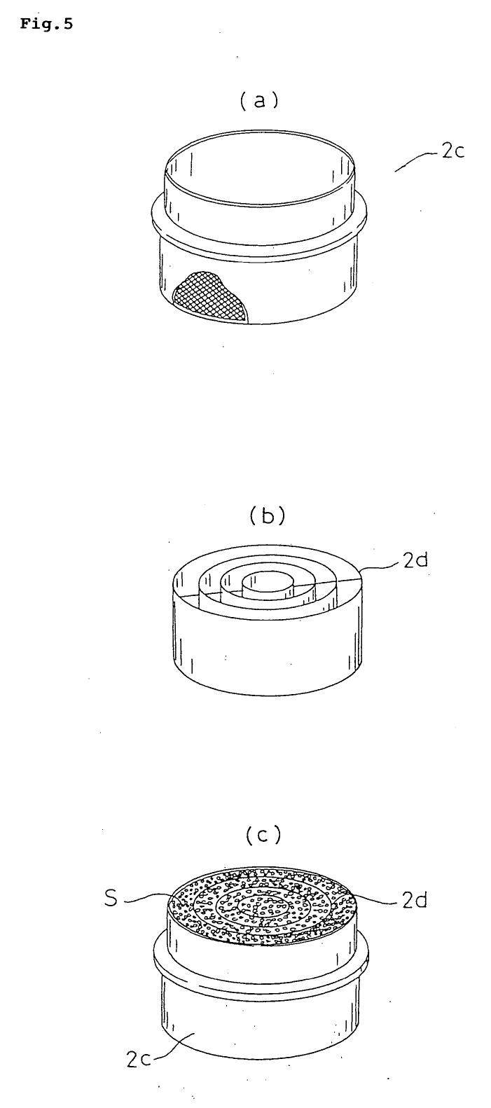

FIG. 5 is a descriptive figure of the inner cylinder constituting a structural component of the extraction device 2, and FIG. 5 (a) shows a perspective view of the inner cylinder 2c. The inner cylinder 2c is formed so as to have dimensions allowing press fitting thereof into the external cylinders, and a net for holding small crushed pieces of raw materials is provided at the bottom thereof. FIG. 5 (b) shows guide plates 2d for insertion into the inner cylinder 2c, and as shown in FIG. 5 (c), the crushed pieces S of coffee beans, soya beans, malt, mung beans, and/or any other desired raw materials are partitioned thereby within the inner cylinder 2c. The presence of the guide plates 2d has the effect of facilitating smoother passage of the atomized fine particles as described hereinafter. Note that these guide plates 2d can also be formed with a spiral shape. As explained above, the extraction device 2 comprises a pair of external cylinders and an inner cylinder fit therein.

Hereinafter, the operation of the manufacturing apparatus will be described in accordance with the construction explained above. Coffee beans shall be used as the raw material in this embodiment. First of all, the inner cylinder 2C as shown in FIG. 5 (a) is charged with rice-sized grains of crushed coffee beans. The weight of the coffee beans at this time is approximately 1,800 grams.

Upon charging, the guide plates 2d as shown in FIG. 5 (b) are disposed inside the inner cylinder 2c. Note that when charging has been completed, the inner cylinder can be covered with a net to hold the coffee beans securely therein.

Next, the inner cylinder 2c is fit into the extraction device 2. While the inner cylinder 2c is fit, water of between 30 and 50 liters is stored in the atomized fine particle generating tank 1 as shown in FIG. 2. Note that the atomized fine particle generating tank 1 is constructed in such a way that the volume of water mentioned above can be automatically maintained.

When the water in the atomized fine particle generating tank 1 and coffee beans serving as the raw material in the extraction device 2 have been setup, the temperature of the water inside the water tank 1 is raised using the heater 1b of the atomized fine particle generating tank 1.

If Korean ginseng is being used as the raw material, experience has shown that a temperature setting 85° C. is most suitable. The temperature of 85° C. is, as described hereinafter, the most suitable for maintaining a temperature of between 60° C. and 70° C. within the extraction device 2.

When the temperature of the water inside the water tank 1 reaches the set temperature of 85° C., the switch for the ultrasonic generator 1a turns on, as does the switch for the blower 5. As a result of the operation of the blower 5, the air flow circulates through a circulatory route formed by the atomized fine particle generating tank 1, the extraction device 2, the condenser 3, the reservoir tank 4, the blower 5, and the communication pipes connecting these components.

Together with the air flow, therefore, the atomized fine particles of water from the atomized fine particle generating tank 1 pass through the plastic pipe P1 and arrive at the extraction device 2. Note that as explained above, a temperature in the range of 60° C. to 70° C. is preferable for the atomized fine particles in the extraction device 2. For this reason, the temperature inside the extraction device 2 is constantly detected by a temperature sensor attached thereto, and in order to achieve the preferable temperature, the temperature in the atomized fine particle generating tank 1 is controlled based on the detected results from the sensor.

Although the air flow circulates through the various devices as a result of the action of the blower 5 as explained above, coffee beans constituting the raw material are charged into the extraction device 2, and the air flow having passed through the plastic pipe P1 thus experiences resistance and the flow thereof is obstructed. In contrast, no obstruction to the passage of the air flow exists in the communication pipe P2 or any downstream components of the circulatory route. Consequently, the air inside the extraction device 2 becomes depressurized.

When the air inside the extraction device 2 becomes depressurized, known and unknown components contained within the pieces of coffee beans constituting the raw material exude to the surface thereof. The passing atomized fine particles capture the components exuded to the surface. As explained above, the temperature within the extraction device 2—or more specifically, the temperature within the inner cylinder 2c—is maintained at approximately 65° C., and therefore, the components contained in the coffee beans are extracted into the atomized fine particles without being destroyed by heat.

The atomized fine particles containing the active components from the coffee beans pass together with the airflow through the connecting pipe P2 and reach the condensing tubes 3a of the condenser 3. The condensing tubes 3a and the cooling plates 3b contained therein are disposed within the cold storage chamber 7 to be cooled, and therefore, the atomized fine particles coming into contact therewith are liquefied and change to water containing active components from the coffee beans. This water containing active components from the coffee beans is instilled into the reservoir tank 4, passing through the drain pipe 6a and being ultimately collected in the secondary reservoir tank 6. Water containing extracted components from the coffee beans and collected in the secondary reservoir tank 6 is filtered in order to remove impurities, and subsequently, water containing extracted components with active components from the coffee beans as the primary component is obtained as a final product.

Meanwhile, the atomized fine particles not liquefied in the condenser 3 pass through the communication pipe P4, are drawn in by the blower 5, and are circulated back to the atomized fine particle generating tank 1 together with the air flow; following this, they again pass through the plastic pipe P1 and are delivered to the extraction device 2.

As explained above, the active components of the coffee beans constituting the raw material are captured into the atomized fine particles as a result of circulation thereof around the circulatory route, and an water containing extracted components containing active components from the coffee beans is obtained through liquefaction of the atomized fine particles; however, the duration of a single operation of the manufacturing apparatus is one hour. That is to say, when extraction was carried out for one hour in accordance with the embodiment explained above and using approximately 1,800 grams of crushed pieces of coffee beans, between approximately 3 and 4 liters of water containing extracted components was ultimately produced.

Although rice-sized grains of crushed coffee beans are used in the embodiment explained above, the size of the crushed pieces can be varied to control the concentration of the active components in the final product. Specifically, the smaller the crushed pieces of coffee beans, the higher the concentration of the product. However, the volume produced per unit time decreases in such a case. Conversely, if the size of the crushed pieces is increased, the volume collected per unit time increases and the concentration decreases.

Guide plates 2d were used within the inner cylinder 2c of the extraction device 2 in accordance with the embodiment explained above, and in contrast to non-usage thereof, this increased the collection volume of water containing extracted components per unit time by approximately 20% and reduced the corresponding concentration.

Non-condensed atomized fine particles in the embodiment of the health drink manufacturing apparatus as explained above are circulated back to the atomized fine particle generating tank 1 via the communication pipe P4 and the blower 5 as shown in FIG. 1, FIG. 2, and FIG. 3, and the temperature thereof drops to approximately 15° C. as a result of cooling in the cold storage chamber 7. In this cooled condition, furthermore, the non-condensed atomized fine particles mix with the atomized fine particles newly generated in the atomized fine particle generating tank 1 and are delivered to the plastic pipe 1; consequently, the temperature of the newly generated atomized fine particles drops, thus leading to condensation thereof and the formation of water drops, and the transfer of atomized fine particles in the plastic pipe P1 is thus obstructed. As a countermeasure for this problem, it is acceptable either to heat a portion of the communication pipe P4 disposed outside the cold storage chamber 7 or to rotate the atomized fine particles delivered to the interior of the atomized fine particle generating tank 1 from the blower 5 using a current plate formed so as to achieve a spiral shape, thus raising the temperature thereof over this interval before re-delivery thereof to the plastic pipe P1.

The water containing extracted components obtained using the manufacturing apparatus and manufacturing method explained above is a transparent, colorless and clean liquid. The liquid can be used as a raw material for medicines or a health drink in its current state; however, solidification of the extraction component contained in the water containing extracted components would not only make storage and transportation easier, but would also significantly increase the convenience as a raw material for various medicines, health foodstuffs, and the like. Hereinafter, an embodiment of the methods for solidification and storage of the extraction component contained in the water containing extracted components will be described.

The procedure for solidification and storage is as follows:
A: a flexible absorber is immersed in the water containing extracted components obtained using the extraction process explained above, and the extracted components contained in the liquid are made to adhere thereto. In order to promote increased penetration of the water containing extracted components into the absorber, it is acceptable to, for example, implement coercive forces such as suction and pressurization through the use of a vacuum pump or the like. In addition, non-woven material comprising a multiplicity of natural fibers and/or synthesized fibers can be used as the flexible absorber, and any of the wide range of commercially-available hydrophilic film filters can be used in this capacity;
B: next, the flexible absorber is dried. By drying the absorber, the extracted components are stored adhered to the fibers thereof. Although freezing and drying, heat drying, air-flow drying, and the like are acceptable, freezing and drying is preferable. Dried extraction products can be stored for a considerable period of time with no degradation. In addition, these dried extraction products can be re-dissolved in solvents such as water, thus allowing liquid solutions containing the active components to be obtained. Where necessary, a pressure is applied for re-dissolution. The dried extraction products can be used for analytic purposes, particularly for the research and development of medicines;
C: through further drying, the absorber holding the solidified extracted components can be compressed. If this type of compression is not executed, loss can result from the detachment and/or floating of fibers during the transportation, storage, or re-dissolution of the absorber; alternatively, as a result of the bulky nature of the absorber, the density of the held solidified extraction component is extremely small when compared with the volume of the absorber capacity, thus leading to the problem of poor efficiency during operations such as transportation, storage, and re-dissolution. Compression can be carried out by a range of different methods such as pressing, the packing of the absorber into a sealed pack by depressurization thereof. When compressed in this way and packed using a non-ventilating material, the compacted absorber can be stored at room temperature or kept in cold storage. As a result of these processes, oxidation of the extracted components can be prevented and the duration over which it can be stored can be dramatically prolonged.

In terms of the retention efficiency and ease-of-use of the extracted components, it is preferable that calcined carbides such as charcoal and activated charcoal or a metal or resin plate containing innumerable surface pores be used as a porous absorber in place of the flexible absorber explained above. Charcoal, activated charcoal, and the like are prepared for use by packing grains of a specific diameter thereof using a porous material so as to form a planar shape. Furthermore, metal or resin plates with porous surfaces mechanically formed so as to contain pores or chemically formed so as to contain countless pores can be used as porous absorbers. Tapered pores and spiral pores allow the area of the attachment surface for the extracted components to be increased and are, therefore, preferable. In addition, pores can be formed on both the front and rear surfaces of metal or resin plates. In the case of such porous absorbers, compression is not required following processes A and B as explained above, and after drying, these absorbers are packed in a non-ventilating film and stored at room temperature or kept in cold storage, if necessary. As these absorbers are planar in shape, benefits are realized in terms of transportation, storage, and handling; furthermore, since this planar shape facilitates rinsing in solvent, re-dissolution of the extracted components can also be executed with extremely high levels of efficiency.

Furthermore, the components according to the present invention have a medical function and are effective as medicines for humans or animals. Specifically, these components are effective in terms of suppression of the occurrence and migration of cancer and tumors, and with respect to diseases such as leukemia, kidney disease, liver disease, hepatitis, diabetes, atopic dermatitis, high blood pressure, high cholesterol, arthritis, rheumatism, AIDS, brain damage, Alzheimer's disease, ear discharge, and Lyme disease.

The dose of the extraction product according to the present invention for the treatment or prevention of sickness is determined in accordance with the sickness in question. The administration volume and frequency are also determined in accordance with age, weight, and patient's reaction to the extracts. In general terms, while the daily dosage of the active components according to the present invention is between 5 and 10 ml, 2 or 3 times daily, a dose of between 30 and 60 ml can be taken 3 or 4 times daily according to the medical conditions. In the case of serious diseases, a dose of 240 ml is taken 3 or 4 times daily for between 7 and 10 days, and following that, the dose is reduced to between 30 and 60 ml. Normally, a dose of approximately 120 ml is taken twice daily.

While various sorts of treatments are known to those skilled in the art, it is preferable that the compositions according to the present invention be administered orally as a liquid form. In addition, these compositions can be combined with other medicines such as analgesics. The compositions can also be administered to both humans and animals such as dogs, cats, and fish; furthermore, the compositions are suitable for use with carriers used in medicines and with other conventional additives. In specific terms, these compositions are suitable for use with water, ethyl alcohol, propylene glycol, glycerin, fillers, lubricating agents, wetting agents, fragrances, coloring, emulsifiers, dispersants, suspension agents, sweeteners, and the like. It is preferable that the extraction products be simply diluted in water and administered orally without the addition of any other solvents or additives. Extraction products refined from raw materials offer remarkable benefits.

In accordance with the configuration and operation as explained above, the present invention allows the efficient low-temperature extraction of components which could not be extracted from various types of raw material using the prior art, the solidification of the components, and the long-term storage thereof in a condition facilitating easy handling; accordingly, said invention can be used in many applications in accordance with the intended purpose of the extracted components produced from various raw materials.

### EXPLANATION OF REFERENCES

1 Atomized fine particle generating tank
2 Extraction device
3 Condenser
4 Reservoir tank
5 Blower
6 Secondary reservoir tank
7 Cooling means

1. A method for the solidification and storage of components extracted from plant, animal, or mineral matter, comprising the steps of;
(a) generating atomized fine particles of water heated using a heater heating stored water to a predetermined temperature and an atomized fine particle generating tank providing a means for atomization of the water;
(b) depressurizing a raw material layer comprising crushed pieces of plant matter, animal matter, mineral matter, or other matter charged in an extraction device and sucking to and exuding out the surface of said atomized fine particles the active components in the raw materials;
(c) absorbing the active components deposited on said raw material surface through suction and exudation into the atomized fine particles by circulating said atomized fine particles together with a flow of air in a cyclic fashion through the various component devices and passing through the depressurized raw material layer;
(d) delivering the atomized fine particles holding the active components to a cooled condenser and condensing the particles;
(e) instilling into a reservoir tank the water containing the active components of the various raw materials after being condensed by the condenser, and for obtaining the finished product;
(f) re-circulating to the atomized fine particle generating tank the atomized fine particles not condensed in the condenser;
(g) making the water containing the extracted components obtained through the preceding processes absorb in a flexible absorber and drying said obtained absorber; and
(h) compressing the absorber holding the extracted components solidified through drying.

2. The method for solidification and storage of components extracted from plant, animal, or mineral matter of claim 1, wherein said flexible absorber is a non-woven material comprising a multiplicity of natural fibers and/or synthesized fibers.

3. A method for the solidification and storage of components extracted from plant, animal, or mineral matter, comprising the steps of;
(a) generating atomized fine particles of water heated using a heater heating stored water to a predetermined temperature and an atomized fine particle generating tank providing a means for atomization of said water;
(b) depressurizing of a raw material layer comprising crushed pieces of plant matter, animal matter, mineral matter, or other matter charged in an extraction device, and sucking to and exuding out the surface of said atomized fine particles the active components in the raw materials;
(c) absorbing the active components deposited on said raw material surface through suction and exudation into the atomized fine particles by circulating said atomized fine particles together with a flow of air in a cyclic fashion through the various component devices and passing through the depressurized raw material layer;
(d) delivering the atomized fine particles holding the active components to a cooled condenser and condensing the particles;
(e) instilling into a reservoir tank the water containing the active components of the various raw materials and condensed by the condenser, and for obtaining the finished product;
(f) re-circulating to the atomized fine particle generating tank the atomized fine particles not condensed in the condenser; and
(g) making the water containing the extracted components obtained through the preceding processes absorb in a porous absorber and drying said obtained porous absorber.

4. The method for solidification and storage of components extracted from plant, animal, or mineral matter of claim 3, wherein said porous absorber is stainless steel formed so as to contain a multiplicity of pores.

5. The method for solidification and storage of components extracted from plant, animal, or mineral matter of claim 3, wherein said porous absorber is resin formed so as to contain a multiplicity of pores.

6. The method for solidification and storage of components extracted from plant, animal, or mineral matter of claim 3, wherein said porous absorber is a calcined carbide.

7. The method for solidification and storage of components extracted from plant, animal, or mineral matter of claim 1, wherein said absorber holding the solidified extraction components is formed so as to be capable of being refrigerated.

8. Components extracted from plant, animal, or mineral matter and held in a flexible absorber as a result of the following;
(a) a process for generating atomized fine particles of water heated using a heater heating stored water to a predetermined temperature and an atomized fine particle generating tank providing a means for atomization of said water;
(b) a process for depressurization of a raw material layer comprising crushed pieces of plant matter, animal matter, mineral matter, or other matter charged in an extraction device, and for suction and exudation of the active components in said raw material to the surface thereof;
(c) a process for absorbing the active components deposited on said raw material surface through suction and exudation into the atomized fine particles by circulating said atomized fine particles together with a flow of air in a cyclic fashion through the various component devices and passing through the depressurized raw material layer;
(d) a process for delivering the atomized fine particles holding the active components to a cooled condenser and condensing the particles;
(e) a process for instillation into a reservoir tank the water containing the active components of the various raw materials after being condensed by the condenser, and for obtaining the finished product;
(f) a process for re-circulating to the atomized fine particle generating tank the atomized fine particles not condensed in the condenser;
(g) a process for absorption of the water containing the extracted components obtained through the preceding processes onto a flexible absorber and for drying of said obtained absorber; and
(h) a process for compression of the absorber holding the extracted components solidified through drying.

9. The components extracted from plant, animal, or mineral matter of claim 8, wherein said flexible absorber is a non-woven material comprising a multiplicity of natural fibers and/or synthesized fibers.

10. Components extracted from plant, animal, or mineral matter and held in a porous absorber as a result of the following;
(a) a process for generating atomized fine particles of water heated using a heater heating stored water to a predetermined temperature and an atomized fine particle generating tank providing a means for atomization of said water;
(b) a process for depressurization of a raw material layer comprising crushed pieces of plant matter, animal matter, mineral matter, or other matter charged in an extraction device, and for suction and exudation of the active components in said raw material to the surface thereof;
(c) a process for absorbing the active components deposited on said raw material surface through suction and exudation into the atomized fine particles by circulating said atomized fine particles together with a flow of air in a cyclic fashion through the various component devices and passing through the depressurized raw material layer;
(d) a process for delivering the atomized fine particles holding the active components to a cooled condenser and condensing the particles;
(e) a process for instillation into a reservoir tank of the water containing the active components of the various raw materials and condensed by the condenser, and for obtaining the finished product;
(f) a process for re-circulating to the atomized fine particle generating tank the atomized fine particles not condensed in the condenser;
(g) a process for absorption of the water containing the extracted components obtained through the preceding processes onto a porous absorber and for drying of said obtained porous absorber;
(h) a process for refrigeration of the porous absorber holding the extracted components solidified through drying.

11. The components extracted from plant, animal, or mineral matter of claim 10, wherein said porous absorber is stainless steel formed so as to contain a multiplicity of pores.

12. The components extracted from plant, animal, or mineral matter of claim 10, wherein said porous absorber is resin formed so as to contain a multiplicity of pores.

13. The components extracted from plant, animal, or mineral matter of claim 10, wherein said porous absorber is calcined carbide.

14. The method for solidification and storage of components extracted from plant, animal, or mineral matter of claim 1, wherein the temperature of the water in said atomized fine particle generating tank is approximately 80° C. or less, and the temperature of said raw material layer and said atomized fine particles is between approximately 60° C. and 70° C.
